(19) United States
(12) Patent Application Publication
(10) Pub. No.: US 2019/0156662 A1
(43) Pub. Date: May 23, 2019

(54) A METHOD FOR ESTIMATING ROAD TRAVEL TIME BASED ON BUILT ENVIRONMENT AND LOW-FREQUENCY FLOATING CAR DATA

(71) Applicant: Dalian University of Technology, Dalian City, Liaoning Province (CN)

(72) Inventors: Shaopeng ZHONG, Dalian City, Liaoning Province (CN); Haimin JUN, Dalian City, Liaoning Province (CN); Yanquan ZOU, Dalian City, Liaoning Province (CN); Kun WANG, Dalian City, Liaoning Province (CN); Kangli ZHU, Dalian City, Liaoning Province (CN)

(21) Appl. No.: 16/076,109

(22) PCT Filed: Oct. 11, 2017
(86) PCT No.: PCT/CN2017/105633

§ 371 Date: Aug. 7, 2018

(30) Foreign Application Priority Data
Dec. 9, 2016 (CN) 201611127783.5

(51) Int. Cl. G08G 1/01

(52) U.S. Cl. CPC G08G 1/0112; G08G 1/0125; G08G 1/0141

(57) ABSTRACT

A method for estimating road travel time based on the built environment and low-frequency floating car data belongs to the technical field of urban traffic management and traffic system evaluation. This invention takes built environment as an explanatory variable of the road travel time. The interpretability of this variable is proved by a numerical example. In addition, this invention develops a method to determine distribution parameters of road travel time using the number distribution of vehicles instead of distance. The benefits of this invention are that: (1) it explains the positive effect of built environment on road travel time; (2) it reflects the speed difference among different road sections, which can improve the precision of estimating road travel time.

### TECHNICAL FIELD

The present invention belongs to an area of urban traffic management and traffic system evaluation, which are concerned with intelligent traffic systems (ITS) and advanced traveler information systems (ATIS). It particularly relates to the explanation of built environment on road travel time and an estimation method of road travel time.

### BACKGROUND

Liu H X proposes a method for predicting travel time on a signal controlled road by using floating car data in combination with traditional loop data and signal lamp phase information. Hellinga B divides each observed total travel time into free-flow time, control delay and congestion delay, and explores how to assign the running time of a floating car between two reports to the corresponding road sections. Rahmani M et al. propose a non-parameter method for estimating path-based travel time based on floating cars whose trajectories coincide with the route to be studied. They assume that the speeds of vehicles on paths and trajectories are stable so that the travel time that vehicles spend on each road section is in direct proportional to the distance they traveled during this time.

### SUMMARY

This invention aims to estimate the distribution of road travel times within and between the road sections using the number of vehicles on the road, used to establish a history travel time database, and which can be the distribution coefficients of travel time instead of distance.

The technical solution of the present invention:

A method for estimating road travel time based on the built environment and low-frequency floating car data are presented as following:

(1) Establish a relationship between the number of report sending and running time

The running time is longer when the road section is congested, and the floating cars are more likely to send a report under this situation. Taking the invent of a floating car sending a report as a random variable, the relationship between the detected number of reports sent by floating cars at each point and the running time at this point is established.

The probability of a floating car sending a report at one point is the same, since the floating car send reports at regular intervals. Set the frequency of the floating car sending a report at each moment is ε, then

$$ɛ = \frac{1}{T}$$

where T is the time interval between two reports.

The probability ρₓ of a floating car reporting a position at point x is in direct proportional to the running time of the floating car at point x:

$${ρ}_{x} = ɛ t ( x ) = \frac{t ( x )}{T} , where t ( x ) < T$$

If the stay time t(x) for a floating car at some point is longer than u report sending periods, i.e., t(x)>uT, where uϵN₊ and

$$u = [ \frac{t ( x ) - T}{T} ] ,$$

then u is the minimum number of report sending; and the probability ρₓ of a float car sending reports u+1 times at point x is

$${ρ}_{x} = ɛ ( t ( x ) - uT ) = \frac{t ( x ) - uT}{T}$$

Assuming that traffic conditions are unchanged during a studied period of time, the running time of a floating car at each point is unchanged. Taking the event of floating cars passing each point as a random event, and supposing that the floating cars perform the same during the studied period, the events of floating cars passing by can be considered as independent repeated experiments and are in accordance with Bernoulli distribution.

Thus, when t(x)<T, the probability pₓ of a floating car sending nₓ reports at point x is

$${p}_{x} ( N = {n}_{x} ) = {C}_{m}^{{n}_{x}} {{ρ}_{x}^{{n}_{x}} ( 1 - {ρ}_{x} )}^{m - {n}_{x}} = {{C}_{m}^{{n}_{x}} ( \frac{t ( x )}{T} )}^{{n}_{x}} {( 1 - ( \frac{t ( x )}{T} ) )}^{m - {n}_{x}}$$

When t(x)>uT, where uϵN₊, in is the estimated number of cars, the probability pₓ of a floating car sending nₓ reports at point x is

$${p}_{x} ( N = {n}_{x} ) = {C}_{m}^{{n}_{x} - mu} {{ρ}_{x}^{{n}_{x} - mu} ( 1 - {ρ}_{x} )}^{m - {n}_{x} + mu} = {{C}_{m}^{{n}_{x} - mu} ( \frac{t ( x ) - uT}{T} )}^{{n}_{x} - mu} {( 1 - ( \frac{t ( x ) - uT}{T} ) )}^{m - {n}_{x} + mu}$$

where 0<nₓ−mu<m, i.e., mu<nₓ<m(u+1). The difference of times that a car send reports on each section is assumed as once at most herein. This assumption is reasonable considering that the present invention uses the low-frequency floating car data.

(2) Establish a relationship between running time, built environment and intersection

A road is divided into a number of sections. The running time of each section depends on its observed and unobserved attributes, including the distance from the section to the downstream intersection, the distance from the section to the crosswalk, and attributes of the road to which the section belongs (such as lane width, the number of lanes, geometric linearity, etc.). Particularly, the influence of built environment attributes on the speed of the section is considered in this invention, such as the interference to motor vehicles caused by pedestrians or other vehicles passing in and out on the speed of the section.

A linear structure is used to represent the influences of the explanatory variables associated with the section running time (regulatory factors such as road grade, geometric linearity of the road and nearby land use attributes) and the length of the specific section on the section running time t′(x), i.e.,

$${t}^{′} ( x ) = {\sum }_{j} {α}_{j} {A}_{j} ∀ x ∈ X$$

where X represents a road; x is one of the sections; Aⱼ represents the value of each explanatory variable affecting the section running time, such as the road grade, the distance to the downstream intersection, etc.; αⱼ are the parameters to be estimated which reflect the influence degree of each explanatory variable on the section running time.

The observed value of a road running time is tₒₖ, ∀kϵK, where k is the observed value of a certain running time, and K is a set of values of the running time. The observed running time of each road is the sum of the running time of each section. The relationship between the observed road and the section can be represented with a K×X incidence matrix R, where rₖₓ is the ratio of the length of each observed value k passing by section x to the total length of the section.

$${t}_{ok} = {\sum }_{x} {t}^{′} ( x ) \times {r}_{kx} ∀ k ∈ K$$

The relationship between running time, built environment and intersection is established above by linear combination. Thus, the estimation of the running time of each section is converted to a maximum likelihood estimation problem:

$$\begin{matrix}max {\prod }_{x} {p}_{x} = {\prod }_{x} {C}_{m}^{{n}_{x}} {{ρ}_{x}^{{n}_{x}} ( 1 - {ρ}_{x} )}^{m - {n}_{x}} \\ = {{C}_{m}^{{n}_{x}} ( \frac{{t}^{′} ( x )}{T} )}^{{n}_{x}} {( 1 - ( \frac{{t}^{′} ( x )}{T} ) )}^{m - {n}_{x}} \\ = {\prod }_{x} {C}_{m}^{{n}_{x}} {{ρ}_{x}^{{n}_{x}} ( 1 - {ρ}_{x} )}^{m - {n}_{x}} \\ = {{C}_{m}^{{n}_{x}} ( \frac{{\sum }_{j} {α}_{j} {A}_{j}}{T} )}^{{n}_{x}} {( 1 - ( \frac{{\sum }_{j} {α}_{j} {A}_{j}}{T} ) )}^{m - {n}_{x}}\end{matrix}$$

where αⱼ are the parameters to be estimated; m is the estimated number of cars; nₓ is the number of cars which send the report.

The value of each parameter can be obtained by solving the model above, and the running time of each section can be calculated using the following equation:

$${t}^{′} ( x ) = {\sum }_{j} {α}_{j} {A}_{j} ∀ x ∈ X .$$

Then, the running time of the road can be calculated according to the incidence matrix of the road and the sections.

(3) Distribute the travel time of road section

The travel time within a section is distributed as follows:

The total running time T on a road is an integral of the running time t″(x) at each point along the road, i.e., T=∫₀^{l}t″(x)dx.

The running time t₁ of a section within the road is an integral of the running time at each point along the section, i.e., t₁=∫ₗ_{₁}^{l}^{₂}t″(x)dx.

The expected value of the number of cars sending reports at a point is equal to a product of the probability p(x) of cars sending a report at the point and the number of tests (i.e., the total number in of cars that pass the point): E(x)=mp(x).

The observed number nₓ of cars which report the positions at the point x is an unbiased estimate of the expected value. In addition, the running time of a floating car at a point is in direct proportional to the probability that it reports the position at this point. Therefore, it is reasonable to consider that the running time of a floating car at a point is proportional to the number of times it reports its position at this point on the road, i.e., t(x) ∝p(x) ∝E(x) ∝nₓ.

Divide a road into several sections, and count the number of times floating cars reporting their positions, then the ratio of the running time of each section to the total running time of the road is equal to the ratio of the total number of times that cars send reports on the section to the total number of times n(x) that cars on the road send reports.

$${α}_{1} = \frac{{t}_{1}}{T} = \frac{{\int }_{{l}_{1}}^{{l}_{2}} {t}^{″} ( x ) dx}{{\int }_{0}^{L} {t}^{″} ( x ) dx} = \frac{{\int }_{{l}_{1}}^{{l}_{2}} n ( x ) dx}{{\int }_{0}^{L} n ( x ) dx}$$

Where α₁ is the ratio of the running time of the first section to the total running time of the road; t₁ is the running time of the first section; l₁ and l₂ are the starting points of the first section and the second section, respectively; L is the end point of the last section.

The travel time between different sections is distributed as follows:

Similarly, to distribute the travel time between adjacent sections, this present invention considers that the event of floating cars passing by any point of two or more sections is an independent repeated test under the same traffic condition. The ratio of the running times of two sections is equal to that of the total number of reports sent by floating cars that pass through both of these two sections:

$$\frac{{T}_{1}}{{T}_{2}} = \frac{{\int }_{0}^{{L}_{1}} {n}^{′} ( x ) dx}{{\int }_{0}^{{L}_{1}} {n}^{′} ( x ) dx}$$

where T₁ and T₂ are the running time of the two sections, respectively; L₁ and L₂ are the length of the two sections, respectively.

The beneficial effects of this invention are as follows: first, built environment attributes are added as explanatory variables of the road running time and prove the interpretability of built environment for the road running time; second, the running time at intersection is added as a part of road travel time and the distance from the intersection is taken as an explanatory variable, which consider the influence of traffic management and control facilities at the intersection on the running time; third, a method for estimating the distribution coefficients of travel time within and between the road sections is developed based on the distribution of the number of cars on the road sections, which can be used to establish a history database of travel time and improve the precision of estimation results of the road travel time.

### DETAILED DESCRIPTION

Detailed steps and simulated effects of the present invention are described as follows.

A method for estimating road travel time based on built environment and low-frequency floating car data consists of the following steps:

1. Calculate the value of parameters corresponding to the variables that affect the running time of road sections in different periods

The design level, geometric linearity and the number of lanes of each section are set as a parameter, which is equivalent to the running time in a study period when the section is far away from intersection and various facilities. Other factors affecting the running time include intersection, signal control, roadside built environment with large pedestrian flow, parking lots, gas stations, i.e. The intersections, schools, hospitals, clinics and gas stations are selected as five types of facilities which have an influence on running time. Distances between each section and the facilities are set as variables which are decreasing functions of distance, because the closer the distance to the facilities, the greater the impact. It is believed that sections more than one kilometer away from facilities are not affected by these facilities anymore since the influence of the facilities can be neglected when the sections are far away from the facilities to a certain extent. The value of a distance variable of each section within one kilometer is 1-distance/1000, while the distance variable of each section beyond one kilometer is 0. It should be noted that for a given road section, only the distance to one downstream intersection is selected as a variable. If signalized intersections, non-signal intersections or other different forms of intersections are regarded as parameters respectively, the number of intersection variables of any road section should be less than or equal to 1.

The division period is 10 minutes, so the values of a set of variables are obtained every ten minutes. The three groups of time between 6:00 and 6:30 are merged into one because the data of floating cars during this period is relatively less and the estimated values of running time have little difference during trial tests. Table 1 shows the estimated coefficients of travel time.

TABLE 1
Estimated coefficients of parameters of travel time

| Time | ID1 | ID2 | ID3 | ID4 | ID5 | ID6 | ID7 | ID8 | ID9 | ID10 | ID11 |
|---|---|---|---|---|---|---|---|---|---|---|---|
| 6:00-6:30 | 0.000 | 0.177 | 0.035 | 0.087 | 0.151 | 0.127 | 0.054 | 0.105 | 0.237 | 0.169 | 0.052 |
| 6:30-6:40 | 0.000 | 0.259 | 0.096 | 0.100 | 0.192 | 0.171 | 0.088 | 0.124 | 0.145 | 0.140 | 0.126 |
| 6:40-6:50 | 0.050 | 0.257 | 0.122 | 0.120 | 0.161 | 0.080 | 0.088 | 0.115 | 0.213 | 0.207 | 0.058 |
| 6:50-7:00 | 0.000 | 0.214 | 0.126 | 0.145 | 0.217 | 0.106 | 0.095 | 0.136 | 0.271 | 0.050 | 0.042 |
| 7:00-7:10 | 0.000 | 0.201 | 0.127 | 0.135 | 0.181 | 0.159 | 0.073 | 0.127 | 0.268 | 0.174 | 0.141 |
| 7:10-7:20 | 0.000 | 0.178 | 0.085 | 0.116 | 0.211 | 0.168 | 0.123 | 0.143 | 0.058 | 0.205 | 0.129 |
| 7:20-7:30 | 0.044 | 1.349 | 0.143 | 0.141 | 0.275 | 0.077 | 0.126 | 0.159 | 0.151 | 0.174 | 0.144 |
| 7:30-7:40 | 0.000 | 0.277 | 0.133 | 0.087 | 0.247 | 0.030 | 0.102 | 0.187 | 0.000 | 0.140 | 0.104 |
| 7:40-7:50 | 0.000 | 0.321 | 0.147 | 0.119 | 0.269 | 0.541 | 0.087 | 0.169 | 0.000 | 0.248 | 0.133 |
| 7:50-8:00 | 0.000 | 0.325 | 0.104 | 0.105 | 0.283 | 0.151 | 0.077 | 0.155 | 0.160 | 0.154 | 0.151 |

| Time | ID12 | ID13 | ID14 | ID15 | ID16 | Intersection | School | Hospital | Clinic | Gas station |
|---|---|---|---|---|---|---|---|---|---|---|
| 6:00-6:30 | 0.036 | 0.215 | 0.067 | 0.108 | 0.135 | 0.047 | 0.041 | 0.038 | 0.064 | 0.064 |
| 6:30-6:40 | 0.045 | 0.182 | 0.090 | 0.109 | 0.125 | 0.059 | 0.015 | 0.056 | 0.052 | 0.020 |
| 6:40-6:50 | 0.061 | 0.121 | 0.097 | 0.102 | 0.164 | 0.055 | 0.006 | 0.071 | 0.038 | 0.013 |
| 6:50-7:00 | 0.092 | 0.186 | 0.130 | 0.153 | 0.250 | 0.009 | 0.024 | 0.004 | 0.040 | 0.031 |
| 7:00-7:10 | 0.107 | 0.188 | 0.137 | 0.182 | 0.193 | 0.000 | 0.006 | 0.067 | 0.075 | 0.071 |
| 7:10-7:20 | 0.094 | 0.219 | 0.141 | 0.155 | 0.251 | 0.029 | 0.017 | 0.112 | 0.059 | 0.018 |
| 7:20-7:30 | 0.125 | 0.253 | 0.102 | 0.166 | 0.143 | 0.040 | 0.000 | 0.101 | 0.053 | 0.000 |
| 7:30-7:40 | 0.132 | 0.104 | 0.117 | 0.129 | 0.260 | 0.015 | 0.002 | 0.118 | 0.116 | 0.003 |
| 7:40-7:50 | 0.133 | 0.105 | 0.118 | 0.159 | 0.160 | 0.014 | 0.001 | 0.116 | 0.090 | 0.040 |
| 7:50-8:00 | 0.107 | 0.167 | 0.132 | 0.147 | 0.219 | 0.000 | 0.000 | 0.176 | 0.101 | 0.074 |

The coefficients of first 16 variables correspond to the running time in the study period when the road section is far away from intersections and various facilities. The coefficients of intersections, schools, hospitals, clinics and gas stations variables indicate the increased running time for each built environment when the distance between a road sections and various facilities is less than one kilometer. The coefficients of all variables are positive, which means that the road section running time has a positive correlation with the built environment.

Table 2 compares the difference of the opposite value of the logarithm of the maximum likelihood function between whether the surrounding built environment attributes are added as explanatory variables or not. As can be seen from the table, the minimum likelihood ratio-2(LL−L0)=30 with 5 degree of freedom and χ²=11.071 when α=0.05, which shows reasonability of taking the built environment as an explanatory variable.

TABLE 2
Comparison of opposite value (−LL) of logarithms of values of maximum
likelihood functions with and without explanatory variable of built environment

| | Time | | | | | | | | | |
|---|---|---|---|---|---|---|---|---|---|---|
| | 6:00-6:30 | 6:30-6:40 | 6:40-6:50 | 6:50-7:00 | 7:00-7:10 | 7:10-7:20 | 7:20-7:30 | 7:30-7:40 | 7:40-7:50 | 7:50-8:00 |
| Including explanatory variable | 2704 | 1554 | 1784 | 2071 | 1723 | 1710 | 1658 | 2644 | 2658 | 2691 |
| of built environment | | | | | | | | | | |
| Excluding explanatory | 2761 | 1572 | 1799 | 2091 | 1744 | 1744 | 1673 | 2660 | 2677 | 3436 |
| variable of built environment | | | | | | | | | | |
| 2(LL − L0) | 114 | 36 | 30 | 40 | 42 | 68 | 30 | 32 | 38 | 1490 |

2. Calculate the running time of a path

Table 3 presents the running time from First Company of Dandong Public Transport Corporation to Dandong Research Academy of Environmental Sciences along Jinshan Avenue based on the obtained parameters. It also sees an increase running time from 6:00 to 8:00.

TABLE 3
Changes of running time from First Company of
Dandong Public Transport Corporation to Dandong
Research Academy of Environmental Sciences along
Jinshan Avenue over time

| | | | Total passed |
|---|---|---|---|
| Time | Travel speed | Travel time | distance |
| 6:00-6:30 | 35.77 | 277.11 | 2753.63 |
| 6:30-6:40 | 34.14 | 290.37 | 2753.63 |
| 6:40-6:50 | 35.25 | 281.23 | 2753.63 |
| 6:50-7:00 | 27.40 | 361.78 | 2753.63 |
| 7:00-7:10 | 26.04 | 380.63 | 2753.63 |
| 7:10-7:20 | 26.98 | 367.37 | 2753.63 |
| 7:20-7:30 | 20.78 | 477.04 | 2753.63 |
| 7:30-7:40 | 20.83 | 476.02 | 2753.63 |
| 7:40-7:50 | 21.09 | 469.93 | 2753.63 |
| 7:50-8:00 | 24.67 | 401.81 | 2753.63 |

The obtained time is basically consistent with “about 2.8 km/5 min” measured by Baidu map, and the gradual increase in travel time from 6:00 also coincides with the actual situation.

We claims:

1. A method for estimating road section travel time based on the built environment and low-frequency floating car data are presented as following:
(1) Establish a relationship between the number of report sending and running time
The running time is longer when the road section is congested, and the floating cars are more likely to send a report under this situation; Taking the invent of a floating car sending a report as a random variable, the relationship between the detected number of reports sent by floating cars at each point and the running time at this point is established;
The probability of a floating car sending a report at one point is the same, since the floating car send reports at regular intervals; Set the frequency of the floating car sending a report at each moment is ε, then
$$ɛ = \frac{1}{T}$$
where T is the time interval between two reports;
The probability ρₓ of a floating car reporting a position at point x is in direct proportional to the running time of the floating car at point x:
$${ρ}_{x} = ɛ t ( x ) = \frac{t ( x )}{T} , where t ( x ) < T$$
If the stay time t(x) for a floating car at some point is longer than u report sending periods, i.e., t(x)>uT, where uϵN₊ and
$$u = [ \frac{t ( x ) - T}{T} ] ,$$
then u is the minimum number of report sending; and the probability ρₓ of a float car sending reports u+1 times at point x is
$${ρ}_{x} = ɛ ( t ( x ) - uT ) = \frac{t ( x ) - uT}{T}$$
Assuming that traffic conditions are unchanged during a studied period of time, the running time of a floating car at each point is unchanged; Taking the event of floating cars passing each point as a random event, and supposing that the floating cars perform the same during the studied period, the events of floating cars passing by can be considered as independent repeated experiments and are in accordance with Bernoulli distribution;
Thus, when t(x)<T, the probability ρₓ of a floating car sending nₓ reports at point x is
$${p}_{x} ( N = {n}_{x} ) = {C}_{m}^{{n}_{x}} {{ρ}_{x}^{{n}_{x}} ( 1 - {ρ}_{x} )}^{m - {n}_{x}} = {{C}_{m}^{{n}_{x}} ( \frac{t ( x )}{T} )}^{{n}_{x}} {( 1 - ( \frac{t ( x )}{T} ) )}^{m - {n}_{x}}$$
When t(x)>uT, where uϵN₊, m is the estimated number of cars, the probability pₓ of a floating car sending nₓ reports at point x is
$${p}_{x} ( N = {n}_{x} ) = {C}_{m}^{{n}_{x} - mu} {{ρ}_{x}^{{n}_{x} - mu} ( 1 - {ρ}_{x} )}^{m - {n}_{x} + mu} = {{C}_{m}^{{n}_{x} - mu} ( \frac{t ( x ) - uT}{T} )}^{{n}_{x} - mu} {( 1 - ( \frac{t ( x ) - uT}{T} ) )}^{m - {n}_{x} + mu}$$
where 0<nₓ−mu<m, i.e., mu<nₓ<m(u+1); The difference of times that a car send reports on each section is assumed as once at most herein; This assumption is reasonable considering that the present invention uses the low-frequency floating car data;
(2) Establish a relationship between running time, built environment and intersection
A road is divided into a number of sections; The running time of each section depends on its observed and unobserved attributes, including the distance from the section to the downstream intersection, the distance from the section to the crosswalk, and attributes of the road to which the section belongs, such as lane width, the number of lanes, geometric linearity; Particularly, the influence of built environment attributes on the speed of the section is considered in this invention, such as the interference to motor vehicles caused by pedestrians or other vehicles passing in and out on the speed of the section;
A linear structure is used to represent the influences of explanatory variables associated with the section running time, regulatory factors such as road grade, geometric linearity of the road and nearby land use attributes, and the length of the specific section on the section running time t′(x), i.e.,
$${t}^{′} ( x ) = {\sum }_{j} {α}_{j} {A}_{j} ∀ x ∈ X$$
where X represents a road; x is one of the sections; Aⱼ represents the value of each explanatory variable affecting the section running time, such as the road grade, the distance to the downstream intersection, etc.; αⱼ are the parameters to be estimated which reflect the influence degree of each explanatory variable on the section running time;
The observed value of a road running time is tₒₖ, ∀kϵK, where k is the observed value of a certain running time, and K is a set of values of the running time; The observed running time of each road is the sum of the running time of each section; The relationship between the observed road and the section can be represented with a K×X incidence matrix R, where rₖₓ is the ratio of the length of each observed value k passing by section x to the total length of the section;
$${t}_{ok} = {\sum }_{x} {t}^{′} ( x ) \times {r}_{kx} ∀ k ∈ K$$
The relationship between running time, built environment and intersection is established above by linear combination; Thus, the estimation of the running time of each section is converted to a maximum likelihood estimation problem:
$$\begin{matrix}max {\prod }_{x} {p}_{x} = {\prod }_{x} {C}_{m}^{{n}_{x}} {{ρ}_{x}^{{n}_{x}} ( 1 - {ρ}_{x} )}^{m - {n}_{x}} \\ = {{C}_{m}^{{n}_{x}} ( \frac{{t}^{′} ( x )}{T} )}^{{n}_{x}} {( 1 - ( \frac{{t}^{′} ( x )}{T} ) )}^{m - {n}_{x}} \\ = {\prod }_{x} {C}_{m}^{{n}_{x}} {{ρ}_{x}^{{n}_{x}} ( 1 - {ρ}_{x} )}^{m - {n}_{x}} \\ = {{C}_{m}^{{n}_{x}} ( \frac{{\sum }_{j} {α}_{j} {A}_{j}}{T} )}^{{n}_{x}} {( 1 - ( \frac{{\sum }_{j} {α}_{j} {A}_{j}}{T} ) )}^{m - {x}_{x}} ,\end{matrix}$$
where αⱼ are the parameters to be estimated; m is the estimated number of cars; nₓ is the number of cars which send the report;
The value of each parameter can be obtained by solving the model above, and the running time of each section can be calculated using the following equation:
$${t}^{′} ( x ) = {\sum }_{j} {α}_{j} {A}_{j} ∀ x ∈ X ;$$
Then, the running time of the road can be calculated according to the incidence matrix of the road and the sections;
(3) Distribute the travel time of road section
The travel time within a section is distributed as follows:
The total running time T on a road is an integral of the running time t″(x) at each point along the road, i.e., T=∫₀^{l}t″(x)dx;
The running time t₁ of a section within the road is an integral of the running time at each point along the section, i.e., t₁=∫ₗ_{₁}^{l}^{₂}t″(x)dx;
The expected value of the number of cars sending reports at a point is equal to a product of the probability p(x) of cars sending a report at the point and the number of tests (i.e., the total number in of cars that pass the point): E(x)=mp(x);
The observed number nₓ of cars which report the positions at the point x is an unbiased estimate of the expected value; In addition, the running time of a floating car at a point is in direct proportional to the probability that it reports the position at this point; Therefore, it is reasonable to consider that the running time of a floating car at a point is proportional to the number of times it reports its position at this point on the road, i.e., t(x)∝p(x)∝E(x)∝nₓ;
Divide a road into several sections, and count the number of times floating cars reporting their positions, then the ratio of the running time of each section to the total running time of the road is equal to the ratio of the total number of times that cars send reports on the section to the total number of times n(x) that cars on the road send reports;
$${α}_{1} = \frac{{t}_{1}}{T} = \frac{{\int }_{{l}_{1}}^{{l}_{2}} {t}^{″} ( x ) dx}{{\int }_{0}^{L} {t}^{″} ( x ) dx} = \frac{{\int }_{{l}_{1}}^{{l}_{2}} n ( x ) dx}{{\int }_{0}^{L} n ( x ) dx}$$
Where α₁ is the ratio of the running time of the first section to the total running time of the road; t₁ is the running time of the first section; l₁ and l₂ are the starting points of the first section and the second section, respectively; L is the end point of the last section;
The travel time between different sections is distributed as follows:
Similarly, to distribute the travel time between adjacent sections, this present invention considers that the event of floating cars passing by any point of two or more sections is an independent repeated test under the same traffic condition; The ratio of the running times of two sections is equal to that of the total number of reports sent by floating cars that pass through both of these two sections:
$$\frac{{T}_{1}}{{T}_{2}} = \frac{{\int }_{0}^{{L}_{1}} {n}^{′} ( x ) dx}{{\int }_{0}^{{L}_{1}} {n}^{′} ( x ) dx}$$
where T₁ and T₂ are the running time of the two sections, respectively; L₁ and L₂ are the length of the two sections, respectively.
